(19) United States
(12) Patent Application Publication
(10) Pub. No.: US 2008/0314088 A1
(43) Pub. Date: Dec. 25, 2008

(54) Finish Cooling Apparatus for Container Glass Machines and Method for Cooling the Finish of a Glass Container During Preforming in a Container Glass Machine

(75) Inventor: Ralf Kammerer, Rheinau (DE)

Correspondence Address: SUGHRUE MION, PLLC, 2100 PENNSYLVANIA AVENUE, N.W., SUITE 800, WASHINGTON, DC, 20037, US

(73) Assignee: GERRESHEIMER GLAS GMBH, DUSSELDORF (DE)

(21) Appl. No.: 12/093,832

(22) PCT Filed: Nov. 24, 2006
(86) PCT No.: PCT/EP2006/011297

§ 371 Date: Aug. 14, 2008

(30) Foreign Application Priority Data
Nov. 25, 2005 (DE) 10 2005 056 600.6
Jun. 15, 2006 (DE) 10 2006 028 122.5

(51) Int. Cl. C03B 9/38; C03B 11/12

(52) U.S. Cl. 65/319

(57) ABSTRACT

The invention relates to a finish cooling unit for a container glass machine for molding a glass container, comprising at least one plunger cylinder having a plunger cylinder cover (6) and a parison mold (4). Said plunger cylinder cover (6) has at least one feed line and at least one channel (PK) with an outlet through which a cooling medium (KM) is guided and exits the channel (PK) in the plunger cylinder cover (6). The cooling medium (KM) for the finish is supplied from a source separate from the source for cooling the parison mold in order to cool the finish of the glass container to be molded independent of the cooling of the parison mold (4). The invention also relates to a method for cooling the finish of a glass container during parison molding in a container glass machine, whereby the finish of the glass container is cooled using a control or adjustment of the pressure of the cooling medium (KM) independent of the cooling of the parison mold.

The present invention relates to a finish cooling apparatus for container glass machines and to a method for cooling the finish of a glass container during preforming in a container glass machine.

In the mechanized container glassmaking sector, a drop is cut from the glass melt in the furnace via a feeder and fed via a trough system to a preform in which a solid body with a certain cavity is formed in accordance with weight and the bottle shape finally targeted later. This generally happens by virtue of the fact that the drop from the glass melt firstly slides via the abovementioned trough system into the preform and is then set or blown downward from above against the mold wall whereupon a cavity is blown into the solid drop body by preblowing from below, as a result of which an upper region of the later glass container, specifically a finish of the later glass container, is already constructed in the lower region of the preform. This method is denoted as blow and blow method. Furthermore, there also exists a press and blow method in which a bottle body is firstly preblown from below and later prepressed via a plunger. In the case of the two abovementioned methods, the glass containers thus preformed, which are still unfinished but already have an incipient inner cavity, are therefore brought from the preform into the finish mold, something which can happen by virtue of the fact that a swinging arm that has a finish support gripping the glass container in the region of its finish brings the preformed glass body from the preform, which is opening for this purpose, into a finish mold, which is likewise opening for this purpose, the glass container being rotated by 180° about its horizontal axis, and the finish thus now pointing upward in the finish mold. After reheating, if appropriate—this glass body is then finally blown into the final shape in the finish mold by blowing into the finish—doing so now from above—whereupon it can be removed after opening of the finish mold (compare to this end, for example, such early publications as Lueger/Matthée Lexikon der Fertigungstechnik [“Dictionary of Production Engineering”], 4th edition, Stuttgart 1967, vol. 8, page 370, this reference from the literature hereby being expressly incorporated by reference into the disclosure content of the document).

This requires coding, both of the preform itself, but also in the region of the finish of the glass container, where the finish support engages with the finish mold.

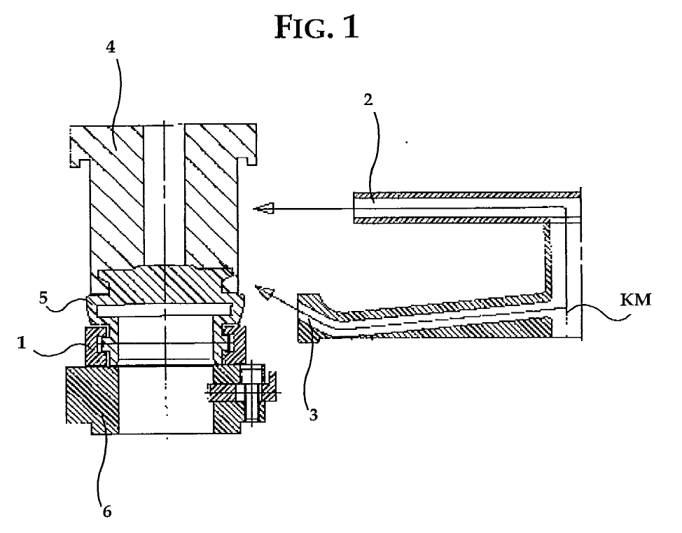

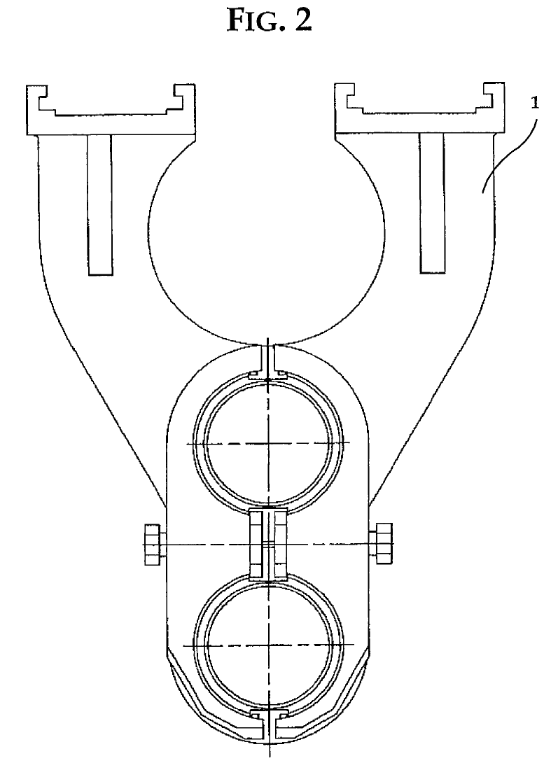

This usually happens by using a nozzle or nozzles, specially provided for the purpose, to cause a cooling medium, for example cooling air, to flow around the finish region and the preform. Such an apparatus according to the prior art can be gathered, for example, from the attached FIG. 1. Reference may be made to the description of the figures that follows later as regards the details.

According to this prior art, there is now the problem that the region of the finish is cooled together with the preform and therefore in no way more strongly than it, but this would be indicated as a rise in the machine throughput, since, after all, at the instant when the preformed glass container is being transported from the preform to the finish mold, the region of the glass container finish in which the finish support engages with the bottle in order to bring it to the finish mold must already be cooled to such an extent that it has sufficient stability no longer to allow an undesired deformation of the glass container during the bringing process, during which forces act, after all.

Attempts have been made in the prior art to improve such instances of preform cooling:

Thus, DE 32 39 095 C2 describes an apparatus that permits the glass body expanding in the mold interior to be fashioned with different wall thicknesses over its height by means of temperature influences of different strength. Preform cooling with similar technical goals have already been taught in DE 25 37 037, which aims to be able to set and maintain any desired temperature profile on the surface of the mold facing the glass.

These developments therefore possibly improve the preform cooling in cases of special application, but they make no contribution to solving the problems mentioned at the beginning.

Again, limits are set here for remedy by increasing the cooling power, since this (see above) always leads to undesirably strong cooling of the preform—particularly given the same cooling air pressure. The consequence would therefore be a lower machine power because of an excessively low finish cooling power.

It is, however, to be found in the prior art that not only preform cooling, but also finish cooling has been the subject matter of various attempts at improvement:

Thus, EP 0 443 949 B1 (corresponding to German document DE 691 04 513 T2) indicates finish cooling provided in addition to preform cooling, but without making more accurate arrangements for the mode of operation; in particular, this document, which only describes a mechanical design, provides no information relating to any possible control or regulating means for the two instances of cooling (preform cooling, on the one hand, and finish cooling, on the other hand). Furthermore, the cooling effect is not optimum in the case of the finish cooling presented in this document, since the heat is dissipated here only by blowing onto the finish region from outside. Moreover, the apparatus has the disadvantage that the channels provided there for the cooling medium always move together with the opening and closing preform halves, and are thus exposed to intense wear which also leads, as a result thereof, to a high susceptibility to maintenance for the apparatus and perceptively impairs the suitability of the latter for mass production, if not, indeed, calling it entirely into question.

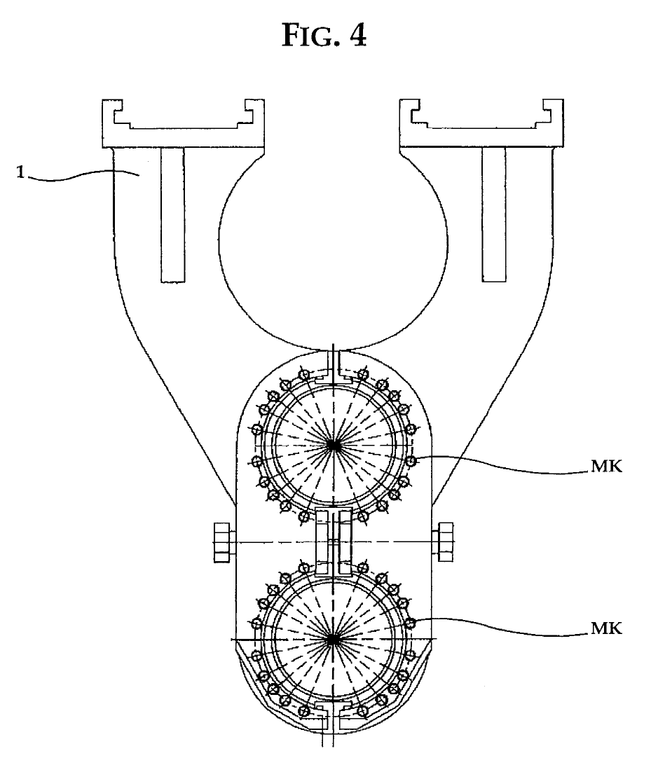

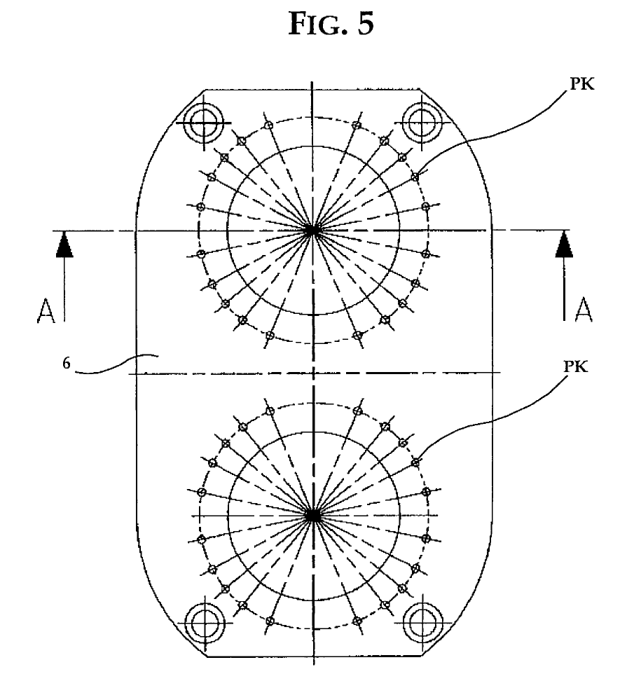

Similar problems are exhibited by the cooling apparatus that is known from DE 36 37 552 C1 which relates solely to finish cooling that, however, feeds the cooling medium via the finish support and the finish mold—consequently, likewise via probable parts correspondingly subject to intense wear. Neither does this document give any information relating to possible control or regulating means or methods for cooling (finish cooling, here); in particular, it gives no information relating to the possible relationship of the finish cooling to the preform cooling, which is itself not described at all in this document. However, because of the fact that glass machines according to the prior art are always operated at a standard station pressure for cooling air, it is clear, nevertheless, that the finish cooling shown here cannot be controlled or regulated independently of the preform cooling. It is merely set forth in more detail that the finish cooling can be used for additional cooling of the bottleneck region after or during opening of the preform halves by means of the channel outlets thereby opening (compare FIG. 5 and the description relating thereto). The cooling effect is also not optimum in the case of this apparatus, since the heat in the actual finish region is dissipated only via the physical contact from finish to finish support and, finally, to the cooling medium. It is only the neck region above the finish that can additionally further be blown upon from outside during opening of the preform.

By contrast, DE 41 18 682 C1 chooses an already improved solution in such a way that it is chosen here to be feed the cooling medium to the finish cooling apparatus, whose main components are in any case no longer moved themselves during operation of the glass machine. Nevertheless, here as well the cooling medium is fed, in a yet more complicated way in terms of design, from the side to the finish mold that itself has cooling channels which must be adjusted with the lateral inlet aligned with the feed channels so that, in any event in the operating position of the finish mold corresponding to the preform, they can accept the cooling medium laterally from the feed channel. To this end, the apparatus therefore has fine adjustment means with the aid of which the feed channels can be height adjusted and therefore adapted to the (end) position of the finish support, something which is associated with considerable outlay on design and construction, and thus with corresponding investment and operating costs. Again, the cooling effect in the case of the finish cooling proposed in this document is likewise not optimum, since in this case, as well, the dissipation of the heat takes place only via the physical contact from finish to finish mold and then to the cooling medium. Likewise, in turn, details for the operation of the apparatus are also lacking here. The document provides no information relating to any possible control or regulating means for the two types of cooling (preform cooling, on the one hand, and finish cooling, on the other hand, and so it is also necessary here to proceed from a common source of cooling media with station pressure according to the prior art).

The above named disadvantage of the requisite fine adjustment in the case of lateral feeding of the cooling medium is avoided by the apparatus according to DE 100 20 431 B4 that—similarly to EP 0 443 949 B1 —simply blows cooling medium from outside onto the finish region from a certain distance. Thus, this apparatus pays for the advantage of wear resistance by the disadvantage of the poorer cooling effect at the finish, something which is, however, not its goal, given that the desire is, after all, merely to cool the preform region on the finish side (mostly the bottle neck) more effectively. It is true that this document does provide general information to the effect that the cooling medium supply valves are intended to serve for regulating, but here, as well, there is a lack, in turn, of more accurate details. Thus, it says nothing as to which control or regulation means for the two types of cooling (preform cooling, on the one hand, and finish cooling, on the other) are to be provided for which cooling process parameters. Thus, it is also necessary here to proceed from a common source with a common station pressure for the cooling medium.

In the case of WO 2002/019964 A1, the cooling air for preform and finish likewise originates from a common source. Thus, it is also impossible in the case of this source for the pressure of the cooling medium for finish cooling actually to be regulated or to be controlled independently of that for preform cooling, since, after all, both cooling media originate from a common source, as is already indicated by the data there relating to the operating pressure of approximately 2 to 3 psi, that is to say approximately 0.14 to 0.21 bar. Such a pressure is typical of the station pressure, which is generated by a fan and is also used for preform cooling, but it is unsuitable for purely independent finish cooling. Consequently, according to the teaching of WO 2002/019964 A1 it is also, in particular, impossible to control or to regulate finish cooling such that the finish cooling is performed without excessive extraction of heat at the preform. With regard to preferred embodiments according to the invention present here, it is to be recorded that according to WO 2002/019964 A1 that neither is the cooling air fed via the plunger cylinder, nor does the latter have a cooling air channel through which the cooling air exits again. Rather, the cooling air is fed here via the station box arranged next to the plunger cylinder cover, and exits once again upward through a bore in a cover plate, something which renders extensive conversions necessary in the event of a change of product.

Consequently, the prior art exhibits no solutions that indicate a finish cooling that is as effective as possible and does not impair preform cooling, but is also simultaneously low in wear and requires little adjustment and thus little maintenance.

It is only in the field of pure preform cooling that the prior art can yield solutions that relate to the problem of feeding the cooling medium with low wear and thus with little maintenance.

Thus, for example, DE 198 19 489 C2 exhibits such a cooling apparatus solely for the preform and which approaches this problem by means of feeder plates into which there have been let openings that then form in a corresponding position a through channel for the cooling medium of the preform.

DE 198 38 698 A1 exhibits, in turn, an apparatus for cooling in the case of which preform cooling and finish cooling are executed in common by means of a continuous cooling circulation that is supplied through the plunger cylinder cover. It is true that this does solve the problem of feeding the cooling medium, via parts that are movable and/or to be adjusted, in a way that is complicated in terms of design and susceptible to wear or is intensive in terms of adjustment, and certainly also improves the cooling effect, but a finish cooling that is stronger by comparison with the preform cooling and thus raises the output of the glass machine is not thereby achieved. On the contrary: according to DE 198 38 698 A1 the goal of the arrangement there is precisely a uniform cooling both of the preform and of the finish mold (compare column 1, penultimate line to column 2, line 2 of DE 198 38 698 A1), something which is targeted by the common cooling circulation of preform and finish cooling that is shown there.

EP 0 187 325 A2 exhibits an apparatus for finish cooling for a container glass machine for forming a glass container, having a plunger cylinder and plunger cylinder cover and a preform, the plunger cylinder cover having a feed line and a channel with an outlet through which a cooling medium is guided and exits in turn from the channel in the plunger cylinder cover for finish cooling. Here as well, however, the cooling air used for finish cooling is also used for preform cooling, something which is therefore in this case also precisely not a finish cooling independent of preform cooling. Moreover, however, EP 0 187 325 A2 has yet a further substantial disadvantage: specifically, the cooling air is guided through the cover ring, something which entails the risk of leaks and can therefore result in cooling air intruding into the interior. Should this happen, however, finish cracks and/or air bubbles therefore form on the glass container to be finished, something which leads, in turn, to tightness problems of the glass container itself; it then suffers from a substantial defect in quality and is thus, ultimately, incapable of being sold and therefore useless to the producer.

It is therefore an object of the present invention to specify a finish cooling for container glass machines that permits finish cooling that is as effective as possible without impairing the preform cooling by excessively strong effect but is also simultaneously low in wear and requires little adjustment and thus little maintenance.

This object is achieved by an apparatus having the features of patent claim 1 and by a method according to patent claim 28. Further advantageous embodiments of the inventive apparatus and of the inventive method follow from the subclaims.

According to the present invention, the embodiment is preferred of a finish cooling apparatus for a container glass machine for forming a glass container that has at least one plunger cylinder, with a plunger cylinder cover, and a preform, the plunger cylinder cover having at least one feed line and at least one channel with an outlet through which a cooling medium is guided and exits in turn from the channel in the plunger cylinder cover, and that is characterized according to the invention in that the cooling medium for the finish comes from a source separate from a source for cooling the preform in order to cool the finish of the glass container to be formed independently of cooling of the preform. Specifically, this embodiment enables a particularly simple feeding of the cooling medium without extensive conversions being necessary in the event of a change of product, as is, for example, the case when the cooling medium is fed via the station box arranged next to the plunger cylinder cover—an approach that is, for example, chosen by WO 2002/019964 A1 (see also above).

The inventive solution can generally be described as follows:

A cooling medium, preferably cooling air, passes via a plunger cylinder into a plunger cylinder cover. There, the cooling medium is guided via a feed line, preferably one annular feed line or feed lines in the shape of two half rings or in the shape of a number of circular segments—for example, let in at the base or at the middle level of the plunger cylinder cover—via channels (preferably vertical ones running approximately parallel to the cylinder wall) that, for example, are introduced all around into the plunger cylinder, being introduced distributed, preferably in a uniformly arcuate fashion, over the circular circumference in plan view of the plunger cylinder, and are, for example, holes, with particular preference 22 or 24 channels, for example holes, per finish. These channels in the plunger cylinder cover are preferably aligned in this case such that an increase in the flow rate of the cooling medium is generated at their outlet from the plunger cylinder cover (preferably at the upper edge thereof, with particular preference exiting vertically there), something which can happen, for example, by providing here an outlet opening that is respectively reduced by comparison with the internal dimension of the channel/channels—for example by reducing the cross section of its outlet opening. This increase in speed of the cooling medium flow at the outlet opening of the respective channel generates an underpressure in the plunger cylinder cover interior, since a slot or else gap (for example preferably with a width of approximately 4/10 to 6/10 parts of a millimeter) is provided between the upper edge of the plunger cylinder cover and the lower edge of the finish support and/or of the finish mold, and there is thus a connection from the plunger cylinder cover interior to the outside. Owing to the underpressure thus generated, venting now takes place in the plunger cylinder cover interior through the abovementioned slot or gap; this venting effect constitutes a preferably desired additional effect, assisting the increase in the rate of production, of the present invention, because other tools move upward and downward in the inner region of the plunger cylinder cover, and there is thus a need to ensure optimum exhaust air so as to exert control against any possible dynamic pressure effects owing to a piston effect through these molds/tools. The air exiting from the plunger cylinder cover—through possible bores, slots or the like there—cools the finish in an axial direction—preferably in an approximately axial direction—(“vertical flow” or else “vertiflow” for short).

This enables finish cooling to be operated independently of preform cooling which, after all, is intended to operate not too intensively because of the impending final blowing of the glass container in the finish mold, in order not to have to heat it there again unnecessarily strongly. In particular, the pressures, volume flows or temperatures of the cooling medium, preferably the cooling air that are required for this purpose can be set independently of those of the preform cooling.

In order to be able to undertake such an independent regulation of the pressure or volume flow, for example, it is possible, for example, to feed the cooling circuits for preform and finish from separate sources for the cooling medium that respectively ensure a pressure sufficient for the purpose at the forward stroke of the control valve.

However, it is also possible to feed them from a common source to the extent it is ensured that the two control valves respectively always have an adequate valve authority, particularly even when the respective other valve is completely open. Thus, if the aim is to control the pressure or volume flow of the cooling medium for finish cooling independently of the preform cooling and in conjunction with a common cooling medium source, the control valve for finish cooling must generally have a valve authority sufficient for control even given a completely open preform cooling valve. In this case, valve authority is understood as the ratio of the pressure difference across a completely open control valve to the pressure difference of the entire hydraulic—here pneumatic—system, including the control valve itself (compare DIN ISO 16484, part 2, number 3.197, October 2004). Which valve authority is required here depends on the relationships in the individual case, but it is usual to recommend a valve authority of more than 0.5 for a technically useful control response (compare, for example, Siemens Publication, Siemens Building Technologies Landis & Staefa Division, Steinhausen, Switzerland, 1997).

However, it is not only possible to control the pressures, volume flows or temperatures of the cooling medium that are required for finish cooling in a fashion independent of those of the preform cooling. Rather, this likewise holds for any possible other parameters coming into question. Thus, it is also possible in a preferred embodiment to measure the temperature at the finish itself and use it as variable to be controlled. Such a measurement can be undertaken, for example, in a contactless fashion—for example by infrared thermometers—(compare, for example, instruments from Newport Electronics GmbH in Germany, for example series OS523 and OS524 with a temperature spectrum of −18° C. to 2482° C.)—for example starting from below through the plunger cylinder and/or plunger cylinder cover interior. However, this purpose can also be served by a temperature measuring cell in, or in the region of the finish mold or of the finish support, use being made here, if appropriate, of suitable thermal conductors in order to obtain defined temperature measurements.

It is also possible, in particular, respectively to set up for this purpose at least one control circuit separate from the preform cooling, or else to set up the control of the parameters in a combined fashion.

In a preferred embodiment of the present invention, in its further course—for example through a further channel in each case, preferably a further hole in each case, now in the finish support and/or finish mold—the flow of the cooling medium is also led past them outside at the level of the finish region of the glass container at its still high rate. It is advantageous to this end to provide the outlet of the respective channel in the plunger cylinder cover below the inlet of a channel, respectively associated herewith, in the finish support and/or finish mold; in any case, in the corresponding (end) position of the finish support and/or finish mold at the preform. Since it is also possible here, in turn, to provide at least one opening (for example venting bore[s]) between the upper edge of the finish support and the lower edge of the preform (for example preferably with a bore cross section of approximately 3 to 10 mm), and the flow of the cooling medium, which is still fast, flows past the outer opening thereof, additional underpressure is thereby now also generated in the interior of the glass container finish, something which generates a further venting flow from this region that in such a way additionally cools the finish interior and so further improves the inventive finish cooling. In this case, it is also possible to provide a further increase in the rate the volume flow—for example in the region of the outlet of the respectively further provided channel through the finish support and/or the finish mold—preferably through the means illustrated here, such as, for example, a further nozzle.

In a further particularly preferred embodiment of the present invention, in order to increase the rate of the cooling medium flow at the upper edge of the plunger cylinder cover, use is (respectively) made of a nozzle whose walls are with particular preference of spherical design in cross section, in order to achieve a particularly strong increase in the flow rate of the cooling medium at the outlet opening. This is particularly advantageous because of the fact that in the case of such high flow rates the volume flow goes only upward in the nozzle outlet direction and not, for example, in any direction of the already mentioned first slot or gap, which after all still continues further outward, between the upper edge of the plunger cylinder cover, and finish support, in order to exit there. This embodiment of the present invention is therefore also particularly advantageously to be combined with the embodiment mentioned immediately before that is dependent on a targeted further guidance of the volume flow into the channel through the finish support and/or the finish mold, which support or which mold is arranged above the plunger cylinder cover—in any case in the operating position, corresponding to the preform, of the finish support and/or the finish mold.

It should not fail to be mentioned that it is also possible for each further nozzle provided according to the present invention, in particular also for those, for example, in the region of the outlet of the channel, respectively further provided, through the finish support and/or the finish mold to be of the above described spherical wall design.

In addition to finish cooling for a container glass machine and the correspondingly equipped container glass machine, the present invention also expressly relates to the corresponding plunger cylinder cover, finish support and/or finish mold construction (with possible bores and/or cooling openings, preferably slots or gaps) or possible further devices disclosed here, as well as to the methods for respectively operating the inventive finish cooling apparatus, presented here according to the invention, for container glass machines, and to the inventive plunger cylinder cover, finish support and/or finish mold construction (with possible bores and/or cooling openings, preferably slots or gaps), as well as to possible further devices disclosed here. In particular, according to the invention also the channel passage through the finish support and, in particular, also through the finish mold can also be performed independently of a feed line through the plunger cylinder and/or plunger cylinder cover, for example, via a different feed line, for example via the station box. The same also holds, in particular, for the underpressure/venting constructions by means of the slot or gap between the upper edge of the plunger cylinder, and the lower edge of the finish support as well as the venting of the finish interior by means of an opening to the finish interior between the upper edge of the finish support and the lower edge of the preform.

With the aid of the present invention, success is now achieved—in the correspondingly arranged embodiment in each case—in
controlling or regulating the parameters (for example pressure, volume flow, temperature) of this cooling separately from the preform cooling such that finish cooling—preferably also forcible-finish cooling is possible without excessive heat extraction at the (entire) preform,
achieving all round cooling, preferably a 360° cooling of the glass container finish by an axial cooling flow, something which enables the glass container to be cooled in the finish region with as little stress as possible—free from stress in the ideal case—as a result of which possible quality problems of the container glass produced are protected or at least still reduced, and
forcing venting and also cooling even of the inner finish region of the glass container (in preform) as a function of injector influence of a cooling medium flowing past.

With the aid of the present invention, it is possible, on the one hand, to extract heat at the finish of the glass container uniformly, that is to say with little stress, without stress in the ideal case, while it is possible, on the other hand, to cool the finish more quickly, indeed much more quickly, than the preform and without excessive extraction at the entire preform, in particular not in its respective upper part, and so to attain a substantially higher production rate of glass containers, since the respective glass container can be brought more quickly to the finished form given quicker cooling of its finish. In this way, a rise in the production rate of 3-8% can be attained, something which leads to a likewise improved machine use in conjunction with approximately the same capital investment, and thus to corresponding savings in costs.

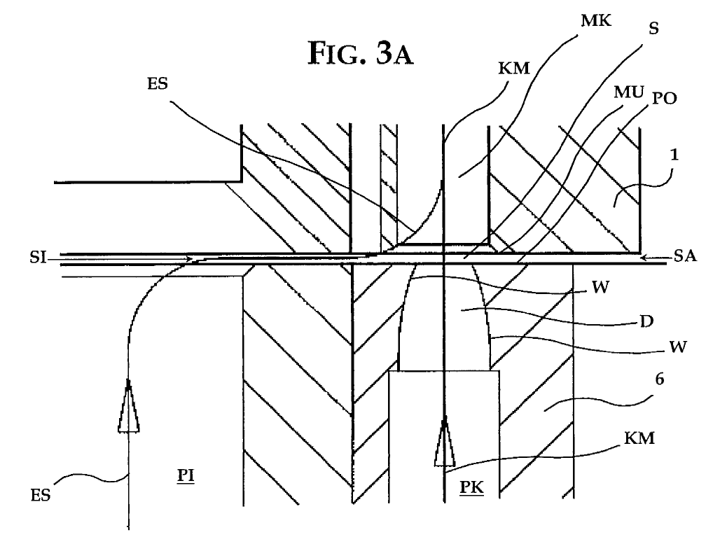

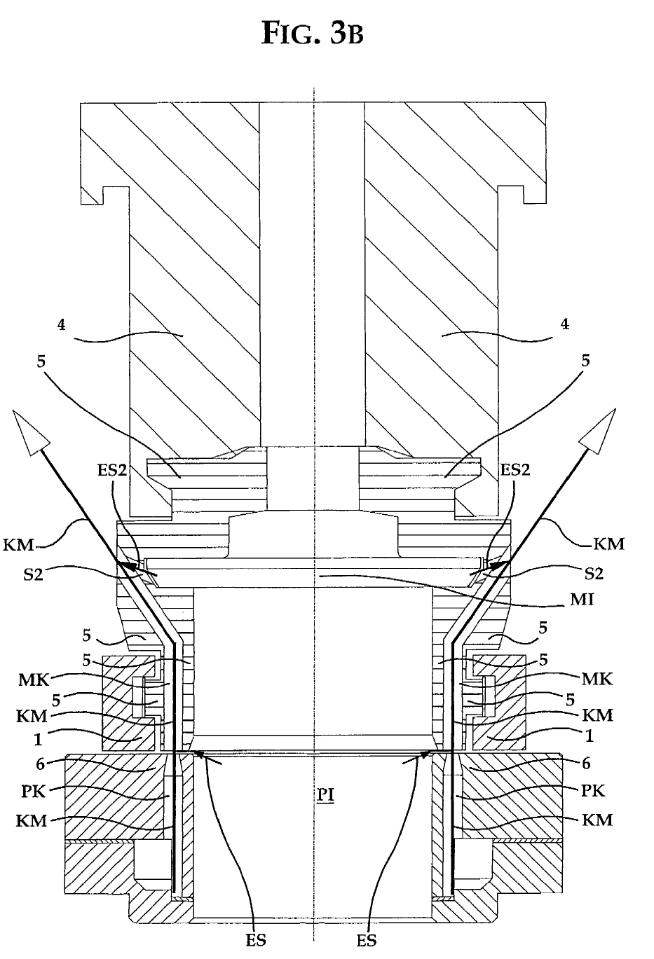

In accordance with common knowledge, the present invention returns the best results in this case by means of the embodiment such as is further illustrated in FIG. 3b, that is to say an embodiment in the case of which a cooling medium flows through a channel in the finish mold, indeed with a further venting flow for venting the finish interior.

In the case of guiding the cooling medium channel through the finish mold itself, it is possible to make a large surface, preferably of approximately 22000 mm² per finish, available for cooling purposes. Again, the cooling is thereby more effective than in the case of guiding the channel through the finish mold, since the heat transfer is not disturbed by unnecessary boundaries.

Thus, given a setting of 160° (note: what is involved here is a time specification, specifically a specification of a relative time that is a function of the duration of a machine cycle of 360°. 160° therefore corresponds to 160°/360°, consequently thus to the 4/9 part of the time that is required for a complete machine cycle!) and a pressure of 3 bar for the cooling air used as cooling medium, it was possible with the aid of this particularly preferred embodiment to lower the finish temperature by 30-35° C., the preform cooling being operated in this case in a fashion independent of the finish cooling, and only serving to cool the preform. If, by contrast, the finish cooling still remains switched on when the preform is open, it also influences the preform temperature. If it is desired to avoid this, the finish cooling should be switched off before or at least at the latest upon opening the preform and switched on again only after or at the earliest upon closing of the preform.

According to the present invention, it is also possible to operate with higher pressures, up to 4 bar, for the finish cooling. If, by contrast, the pressure of the cooling air is reduced to 2 bar, a more pronounced temperature rise at the finish can be detected by comparison with a pressure of 3 bar. If, nevertheless, the aim is to attain a higher cooling power in conjunction with a lower pressure—that is to say, approximately 2 bar or 1.5 bar or 1.0 or even only 0.5 bar—this can be achieved by means of larger cross sections of the cooling medium channels and/or larger cross sections of the feed lines for the cooling medium.

The separate source for the cooling medium for finish cooling can preferably be operated (for example, regulated or else controlled) according to the invention in all abovementioned pressure ranges or in the case of all the abovementioned pressures.

A further advantage of the inventive apparatus also resides in the circumstance that guiding the cooling medium through at least one channel in the plunger cylinder cover results in a self cleaning effect as a consequence of the thus continuously performed blowing away of impurities, which is able also to contribute to the insusceptibility of the inventive apparatus to errors.

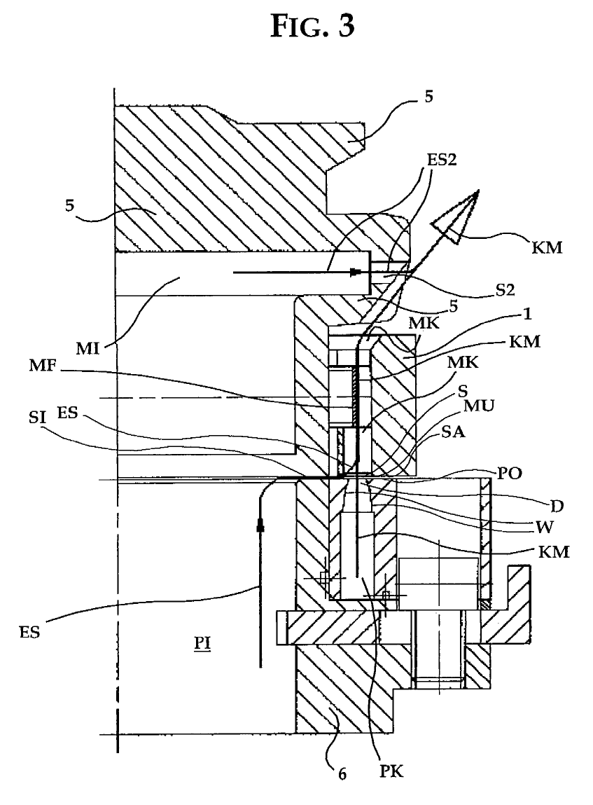

One example each from the prior art are discussed below in FIGS. 1 and 2 and, moreover, exemplary embodiments of the present invention that are not to be understood as restrictive are discussed in the following figures with the aid of the drawing, in which:

FIG. 1 shows from the side a cross section through a glass machine according to the prior art in the region relevant here, with preform, finish mold, finish support, plunger cylinder lid, cooling nozzle for preform and cooling nozzle for the finish with a cooling air flow,

FIG. 2 shows a plan view of a finish support according to the prior art in a plan view from below, specifically in the (end) position, corresponding to the finish mold, of the finish support, or from above, and specifically in the (end) position corresponding to the preform,

FIG. 3 shows from the side a cross section through a glass machine in an embodiment according to the present invention in the region relevant here with finish region, finish mold, finish support and plunger cylinder cover, in the case of which a cooling medium flows through a channel in the finish support,

FIG. 3a shows an enlarged detail of a part of the illustration according to FIG. 3 that shows in more detail the slot or gap between the upper edge of the plunger cylinder cover and lower edge of the finish support, and also the venting flow flowing therethrough,

FIG. 3b shows from the side a cross section through a glass machine in a further embodiment according to the present invention in the region relevant here with finish region, finish mold, finish support and plunger cylinder cover, in the case of which a cooling medium flows through a channel in the finish mold, specifically with a further venting flow for venting the finish interior,

FIG. 3c shows from the side a cross section through a glass machine in the embodiment according to FIG. 3b in the region relevant here with finish region, finish mold, finish support and plunger cylinder cover, in which a cooling medium flows through a channel in the finish mold, but here without additional venting of the finish interior,

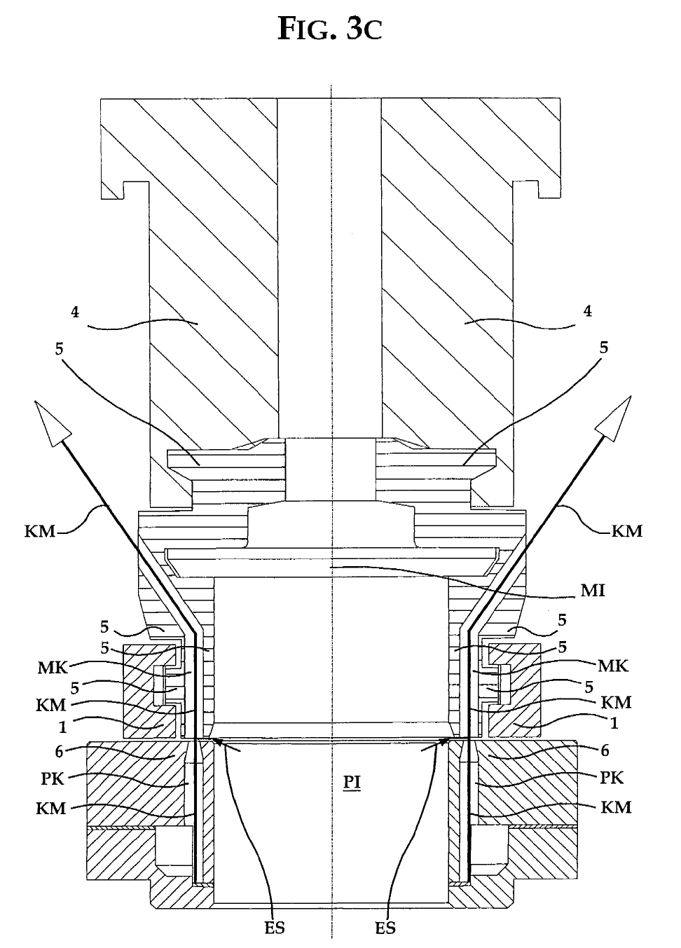

FIG. 4 shows in a view from below an embodiment of a finish support according to the present invention, specifically in the (end) position, corresponding to the finish mold, of the finish support, or from above, specifically in the (end) position corresponding to the preform,

FIG. 5 shows a view from above of a plunger cylinder cover, according to the present invention with nozzle openings of channels for a cooling medium, here holes, that are likewise arranged vertically in the shape of a circle, and

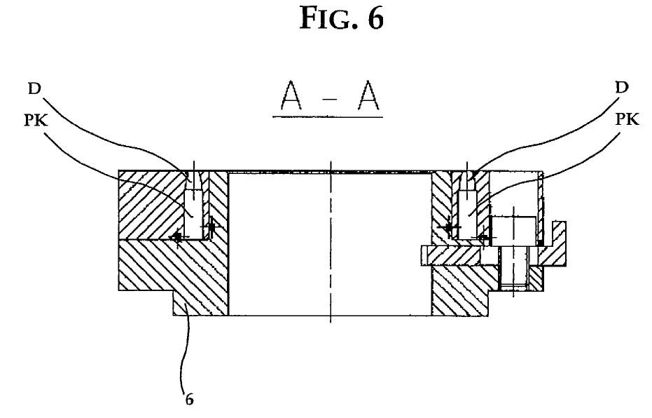

FIG. 6 shows from the side a cross section through a plunger cylinder cover, according to the present invention with channels for a cooling medium, here holes, and a spherical nozzle at the outlet of the respective channel.

FIG. 1 shows from the side a cross section through a glass machine according to the prior art in the region relevant here with preform 4, finish mold 5, finish support 1, plunger cylinder cover 6, preform cooling nozzle 2 and finish cooling nozzle 3 with a cooling air flow KM.

FIG. 2 shows a view of a finish support 1 according to the prior art in a view from below—in the (end) position corresponding to the finish mold, of the finish support—or from above, specifically in the (end) position corresponding to the preform.

FIG. 3 shows from the side a cross section through a glass machine in an embodiment according to the present invention in the region relevant here with finish region, finish mold 5, finish support 1 and plunger cylinder cover 6 in a detailed illustration in the case of which a cooling medium KM flows through a channel MK in the finish support 1.

Here, a cooling medium KM, for example cooling air, passes into the plunger cylinder cover 6, preferably from a source—separate from the source to be used for the preform—via channels PK, preferably arranged in the shape of a circle at regular arcuate spacings (compare also FIG. 5), with particular preference twenty-four holes PK in the plunger cylinder cover 6. From there, the cooling air KM is guided through the finish support 1 via channels MK (compare also FIG. 4) likewise preferably arranged in the form of a circle at regular arcuate spacings, once again with particular preference twenty-four holes per finish, inlet openings of the through channels MK in the finish support being arranged above outlet openings of channels PK in the plunger cylinder when the finish support is located in the operating position corresponding to the preform. The channels PK in the plunger cylinder cover are fashioned by means of a reduced outlet cross section—by means of a nozzle D designed with a spherical inner wall W—such that a—preferably particularly sharp—increase in the rate of the cooling medium flow KM takes place at the outlet of the channel PK at the upper edge PO of the plunger cylinder cover 6. As a consequence of this and of the slot or gap S between the upper edge PO of the plunger cylinder cover 6 and the lower edge MU of the finish support 1, an underpressure forms in the plunger cylinder cover interior PI, and a venting current ES (a first venting) flows through the inner region SI of the slot (or else gap) S toward the cooling medium flow KM quickly exiting from the nozzle D. The particularly high rate of the volume flow KM attained by means of the spherical inner wall W of the nozzle at the outlet of the channel PK, which here also sucks the venting flow ES through the slot or gap region SI, has the effect that the total volume flow KM thus formed is blown virtually exclusively upward into the channel MK —which leads through the finish support 1—and does not lead outside through the further region chasm SA, lying outside, of the slot or gap S.

This volume flow KM then flows further in an axial fashion through the channel MK, a finish support spring MF that is respectively possibly located there immediately also being cooled, and this at the same time counteracts a premature loss of temper of the finish support spring MF there. The finish support spring MF serves to center the finish mold 5 in the finish support 1, something which can lead to a decentering in conjunction with one-sided wear as a consequence of loss of temper of the spring MF and thus to quality problems, for example cracks in the glass container. This is counteracted at the same time by the embodiment, to be seen here, of the present invention. The previously mentioned volume flow KM then leads outside past the finish region, and thus also past the finish mold 5, and once again generates here an underpressure in the finish interior MI by means of the openings there, preferably venting bores S2 and the Venturi principle already used previously for the first venting. This additional venting (second venting) thus ensures forced venting via the further venting flow ES2 in this region of the finish mold 5 as well (preferably the cover ring region, cover ring not being illustrated here), and thus improves the present invention once again. It is to be remarked here that guiding the cooling medium flow KM from outside past the finish region or finish mold 5 can, of course, —as already described above in the general part—also to be formed according to the invention independently of the passage of the cooling medium KM through in each case a further channel or a further hole such as here, for example, through a channel MK in the finish support 1 or, preferably, also in the finish mold 5 itself.

FIG. 3a shows a large detail of a part of the illustration according to FIG. 3, specifically the slot or gap S between the upper edge PO of the plunger cylinder cover 6 and lower edge MU of the finish support 1, and also, in more detail, the venting flow ES flowing therethrough. The reference symbols further specified correspond to the meaning already known from FIG. 3.

FIG. 3b shows a cross section through a glass machine in a further embodiment according to the present invention from the side in the region relevant here with finish region, finish mold 5, finish carrier 1 and plunger cylinder cover 6, in the case of which a cooling medium KM flows through a channel MK in the finish mold 5, specifically with a further venting flow ES2 for venting the finish interior MI.

Here, as well, a cooling medium KM, for example cooling air, passes into the plunger cylinder cover 6, preferably from a source—separate from the source to be used for the preform—via channels PK, preferably arranged in the shape of a circle at regular arcuate spacings (compare also FIG. 5), with particular preference twenty-four holes PK in the plunger cylinder cover 6. From there, the cooling air KM is guided now here through the finish mold 5 instead of through the finish support 1 via channels MK likewise preferably arranged in the form of a circle at regular arcuate spacings, once again with particular preference twenty-four holes per finish, inlet openings of the through channels MK here, however, in the finish support 5 and not in the finish support 1 of channels PK in the plunger cylinder when the finish support is located in the operating position corresponding to the preform. The channels PK in the plunger cylinder cover are fashioned by means of a reduced outlet cross section—here, for example, by means of a nozzle—such that a—preferably particularly sharp—increase in the rate of the cooling medium flow KM takes place at the outlet of the channel PK at the upper edge of the plunger cylinder cover 6. As a consequence of this and of a slot or gap between the upper edge of the plunger cylinder cover 6 and the lower edge of the finish mold 5 and/or the lower edge of the finish support 1 an underpressure forms in the plunger cylinder cover interior PI, and a venting current ES (a first venting) flows through the inner region of the slot (or else gap) toward the cooling medium flow KM quickly exiting from the nozzle. The particularly high rate of the volume flow KM attained by means of the nozzle at the outlet of the channel PK, which here also sucks the venting flow ES through the slot or gap region, has the effect that the total volume flow KM thus formed is blown virtually exclusively upward into the channel MK —that leads here in this embodiment according to the present invention through the finish mold 5 instead of through the finish support 1—and does not lead outside through the further region lying outside, of the slot or gap.

This volume flow KM then flows further axially through the channel MK, specifically a bore or other type of channel configuration in the finish mold 5. The previously mentioned volume flow KM then leads outside past the finish region, and once again generates here an underpressure in the finish interior MI by means of the openings there, preferably venting bores S2 and preferably by utilizing the Venturi principle likewise already used previously for the first venting. This additional venting (second venting) thus ensures forced venting via the further venting flow ES2 in this region of the finish mold 5 as well (preferably the cover ring region, cover ring not being illustrated here), and thus improves the present invention once again. It is to be remarked here that guiding the cooling medium flow KM from outside past the finish region can, of course, —as already described above in the general part—also to be formed according to the invention independently of the passage of the cooling medium KM through in each case a further channel or a further hole such as, for example, here by a channel MK in the finish mold 5.

FIG. 3c shows, from the side here as well, a cross section through a glass machine in the embodiment according to FIG. 3b in the region relevant here with finish region, finish mold 5, finish support 1 and plunger cylinder cover 6, in the case of which a cooling medium KM flows through a channel MK in the finish mold 5, but here without additional venting of the finish interior MI by a further venting flow by means of an opening in the finish region. The reference symbols specified further correspond here to the meaning already known from FIG. 3b or FIG. 3.

FIG. 4 shows an embodiment of a finish support 1 according to the present invention in a view from below —in the (end) position, corresponding to the finish mold, of the finish support 1—or from above—in the (end) position corresponding to the preform—specifically with upper outlet openings—“upper” outlet openings seen in the (end) position, corresponding to the preform, of the finish support 1—of channels MK of the finish support 1 for a cooling medium—holes here—that are arranged uniformly in the shape of a circle—apart from the exception of the holes at the 12 o'clock and 6 o'clock positions—arranged here at the same arcuate spacings.

FIG. 5 shows a view from above of a plunger cylinder cover 6 according to the present invention with nozzle openings of channels PK—holes here—for a cooling medium that are likewise arranged regularly in the shape of a circle and are preferably positioned below the lower inlet openings of the channels of the finish support (through channel or channels MK from FIGS. 3, 3a, 4), this preferably being so in any event whenever the finish support is located in the operating position corresponding to the preform. The section along A-A indicated here is then to be seen in lateral illustration in FIG. 6.

FIG. 6 shows the cross section A-A from the side through a plunger cylinder cover 6 according to FIG. 5 in accordance with the present invention with channels PK for a cooling medium—holes here—that are likewise regularly arranged in the shape of a circle (compare FIG. 5), and a nozzle D, provided with a spherical inner wall, at the outlet of the respective channel.

1. An apparatus for finish cooling for a container glass machine for forming a glass container, having at least one preform (4) and at least one plunger cylinder with plunger cylinder cover (6), the plunger cylinder cover (6) having at least one feed line and at least one channel (PK) with an outlet through which a cooling medium (KM) is guided for finish cooling and exits again from the channel (PK) in the plunger cylinder cover (6), and that permits pressure and/or volume flow and/or temperature of the cooling medium (KM) for finish cooling to be st independently of perform cooling, in ordr to cool the finish of the glass container to be formed independently of cooling of the preform (4).

2. The apparatus for finish cooling for a container glass maching as claimed in claim 1, characterized in that the pressure of the cooling medium (KM) for finish cooling is set at at least 0.5 bar.

3. The apparatus for finish cooling for a container glass machine as claimed in claim 1, characterized in that the container glass machine also has at least one finish support (1) with at least one channel (MR) through which the cooling medium (KM) for cooling the finish is guided.

4. The apparatus for finish cooling for a container glass machine as claimed in claim 3, characterized in that, after it has exited from the plunger cylinder cover (6), the cooling medium (KM) is guided throught the further channer (MK) in the finish support (1) and is then further led past from outside at the level of the finish region of the glass container.

5. The apparatus for finish cooling for a container glass machine as claimed in claim 4, characterized in that the container glass machine also has at least one finish tool (5), and the cooling medium (KM) is led passed from outside at the level of the finish region of the glass container by being led passed the finish tool (5).

6. The apparatus for finish cooling for a container glass machine as claimed in claim 4, characterized in that the container glass machine also has at least one finish support spring (MF) that serves for centering the finish tool (5) in the finish support (1) and is located in the channel (MK) in the finish support (1).

7. The apparatus for finish cooling for a container glass machine as claimed in claim 1, characterized in that it also has at least one finish tool (5) with at least one channel (MK) through which the cooling medium (KM) for cooling the finish is guided.

8. The apparatus for finish cooling for a container glass machined as claimed in claim 7, characterized in that, after it has exited from the plunger cylinder cover (6), the cooling medium (KM) is guided through the further channel (MK) in the finish tool (5) and is then further led past from outside at the level of the finish region of the glass container.

9. The apparatus for finish cooling for a container glass machine as claimed in claim 3, characterized in that at least one outlet of at least one channel (MK) in the finish support (1) or in the finish tool (5) is configured such that an increase in the flow rate of the cooling medium (KM) is generated there.

10. The apparatus for finish cooling for a container glass machine as claimed in claim 1, characterized in that at least one outlet of at least one channel (PK) in the plunger cylinder over (6) is arranged at the upper edge (P0) of the plunger cylinder cover (6).

11. The apparatus for finish cooling for a container glass machine as claimed in claim 10, characterized in that a number of outlets of channels (PK) in the plunger cyliner cover (6) at the upper edge (P0) of the plunger cylinder cover (6) are arranged distributed, preferably in a uniformly arcuate fashion, all around over a circular circumference in plan view of the plunger cylinder.

12. The apparatus for finish cooling for a container glass machine as claimed in claim 1, characterized in that at least one outlet of at least one channel (PK) in the plunger cylinder cover (6) is configured such that an increase in the flow rate of the cooling medium (KM) is generated there.

13. The apparatus for finish cooling for a contatiner glass machine as claimed in claim 3, characterized in that the outlet of the respective channel (PK) in the plunger cylinder cover (6) is arranged below an inlet of the respective channel (MK) in the finish support (1) or finish tool (5) when the finish support (1) or the finish tool (5) is or are located in the operating position corresponding to the perform (4)

14. (canceled)

15. The apparatus for finish cooling for a container glass machine as claimed in claim 4, characterized in that an opening (S2) to the finish interior (MI) is provided between the upper edge of the finish support (1) and the lower edge of the preform (4), the result being that an underpressure is generated as a consequence of the flow rate of the cooling medium (KM) at the outlet of the respective channel (MK) in the finish support (1) or in the finish tool (5), and venting ( (ES2) thereby takes place through the opening (S2) in the finish interior (MI).

16. An apparatus for finish cooling for a container glass machine for forming a glass container, having at least one preform (4) and at least one plunger cyllinger with plunger cylinder cover (6), the plunger cylinder cover (6) having at least one feed line and at least one channel (PK) with an outlet through which a cooling medium (KM) is guided for finish cooling and exits again from the channel (PK) in the plunger cylinder cover (6), and that permits pressure and/or volume flow and/or temperature of the cooling medium (KM) for finish cooling to be set independently of preform cooling, in order to cool the finish of the glass container to be formed independently of cooling of the preform (4);
characterized in that at least one outlet of at least one channel (PK) in the plunger cylinder cover (6) is configured such tat an increase in the flow rate of the cooling medium (KM) is generated there;
characterized in that the outler of the respective (PK) in the plunger cylinder cover (6) is arranged below an inlet of the respective channel (MK) in the finish support (1) or finish tool (5) when the finish support (1) or the finish tool (5) is or are located in the operating position corresponding to the preform (4); and
characterized in that a slot or gap (S) is formed between the upper edge (PO) of the plunger cylinder cover (6) and the lower edge (MU) of the finish support (1) or of the finish tool (5) when the finish support (1) or the finish tool (5) is or are located in the operating position corresponding to the perform (4), the result being that an underpressure is generated a consequence of the flow rate increase of the cooling medium (KM) at the outlet of the respective channel (PK) in the plunger cylinder cover (6), and venting (ES) thereby takes place through the slot or gap (S) in the plunger cylinder cover interior (PT).
